(19) United States
(12) Patent Application Publication
(10) Pub. No.: US 2021/0060879 A1
(43) Pub. Date: Mar. 4, 2021

(54) METHOD FOR REPAIRING TIRE TREAD USING A PATCH MADE VIA THREE-DIMENSIONAL PRINTING

(71) Applicant: Bridgestone Americas Tire Operations, LLC, Nashville, TN (US)

(72) Inventors: Anoop G. Varghese, Fairlawn, OH (US); Thomas A. Sams, Alliance, OH (US)

(21) Appl. No.: 16/553,282

(22) Filed: Aug. 28, 2019

(51) Int. Cl. B29C 73/10; B29C 73/06; B29C 35/02

(52) U.S. Cl. CPC B29C 73/10; B29L 2030/002; B29C 35/02; B29C 73/06

(57) ABSTRACT

Various method for repairing a tire tread are provided. In one embodiment, a method for repairing a tire tread is provided, the method comprising: providing a tire having a tire tread portion, wherein the tire tread portion includes at least one of a tread block and a tread rib, and wherein at least one of the tread block and the tread rib includes a void resulting from wear or damage of the tire tread portion; scanning the void with a 3D scanner to create a 3D computer model of the void; generating a negative of the void via the 3D computer model, the negative corresponding to a positive removed element representing the material removed from the void; 3D printing a removed element copy using a polymer material; applying an adhesive to at least one surface of the void; applying the removed element copy to the void; and curing the adhesive.

### CROSS-REFERENCE TO RELATED APPLICATIONS

This application claims priority from U.S. Provisional Patent Application No. 62/732,716, filed on Sep. 18, 2018, which is incorporated by reference herein in its entirety.

### BACKGROUND

Tires used on vehicles typically wear with use via interaction with the hard surfaces upon which the vehicle is operated. Due to a variety of factors, the wear can be irregular. Irregular wear is generally tire wear that is not uniform across the width of a contact patch of a tire about its entire circumference. For example, some tires may develop heel-toe wear, which may result in tread blocks with higher wear on a heel portion or toe portion (relative to the direction of rotation), and which may be caused by out of specification tire/wheel alignment. Additionally, a tire's tread may wear more in the axially outer edges of the tread, or axially inner portion of the tread, which may be caused by under inflation or over inflation, respectively.

In some instances, tires may develop a localized section of high wear, which may initially be limited to a specific circumferential section of a tire's tread. For example, a tire may experience a circumferentially-localized area of high wear in a shoulder rib/shoulder blocks due misalignment or the input of small steering angle to overcome a road crown. In another example, a tire may experience irregular wear in any localized section of a tread, due to any of a variety of factors. Inevitably, irregular wear that may initially be localized, will propagate through at least some of the rest of the tread, an perhaps circumferentially around the tread. Once the irregular wear propagates, the life of the tire tread is typically much shorter than the same tire tread without irregular wear.

Additionally, a tire's tread may be damaged via contact with sharp rocks, metal, etc. that may be present in a roadway or off-road location. This damage may result in the tire's tread, for example, a tread block, having a large portion cut or torn away. This area of localized damage may propagate due to the void in the ground-contacting portion of the tread.

When irregular wear or tire tread damage is recognized early, and has not propagated through the entirety of the tread, the tire tread may be repaired to extend the life of the tire and delay or prevent propagation of wear. What is needed is a method for repairing a tire tread that experiences uneven wear or damage.

### SUMMARY

In one embodiment, a method for repairing a tire tread is provided, the method comprising: providing a tire having a tire tread portion, wherein the tire tread portion includes at least one of a tread block and a tread rib, and wherein at least one of the tread block and the tread rib includes a void resulting from wear or damage of the tire tread portion; scanning the void with a 3D scanner to create a 3D computer model of the void; generating a negative of the void via the 3D computer model, the negative corresponding to a positive removed element representing the material removed from the void; 3D printing a removed element copy using a polymer material; applying an adhesive to at least one surface of the void; applying the removed element copy to the void; and curing the adhesive.

In another embodiment, a method for repairing a tire tread is provided, the method comprising: providing a tire having a tire tread portion, wherein the tire tread portion includes at least one of a tread block and a tread rib, and wherein at least one of the tread block and the tread rib includes a void resulting from wear or damage of the tire tread portion; scanning the void with a 3D optical scanner to create a 3D computer model of the void; generating a negative of the void via the 3D computer model, the negative corresponding to a positive removed element representing the material removed from the void; 3D printing a removed element copy using a polymer material; applying an adhesive to at least one surface of the void; applying the removed element copy to the void; and curing the adhesive.

In another embodiment, a method for repairing a tire tread is provided, the method comprising: providing a tire having a tire tread portion, wherein the tire tread portion includes at least one of a tread block and a tread rib, and wherein at least one of the tread block and the tread rib includes a void resulting from wear or damage of the tire tread portion, the void forming a residual surface in at least one of the tread block and the tread rib; scanning the void with a 3D optical scanner to create a 3D computer model of the void; generating a negative of the void via the 3D computer model, the negative corresponding to a positive removed element representing the material removed from the void; 3D printing a removed element copy using a polymer material; applying an adhesive to the residual surface of the void; applying the removed element copy to the residual surface of the void; and curing the adhesive.

### BRIEF DESCRIPTION OF THE DRAWINGS

The accompanying figures, which are incorporated in and constitute a part of the specification, illustrate various example configurations and methods, and are used merely to illustrate various example embodiments. In the figures, like elements bear like reference numerals.

FIG. 1A illustrates a sectional view of an example tire 100 without irregular wear.

FIG. 1B illustrates a perspective view of example tire 100 without irregular wear.

FIG. 2A illustrates a sectional view of an example tire 200 with irregular wear.

FIG. 2B illustrates a perspective view of example tire 200 with irregular wear.

FIG. 2C illustrates a sectional view of example tire 200 with irregular wear being scanned with a scanner 230.

FIG. 2D illustrates an elevational view of example tire 200 with irregular wear being scanned with scanner 230.

FIG. 3A illustrates a sectional view of an example tire 300 with a removed element copy applied to a void.

FIG. 3B illustrates a perspective view of example tire 300 with a removed element copy applied to a void.

FIG. 4A illustrates an elevational view of an example tire 400 with heel-toe wear.

FIG. 4B illustrates an elevational view of a tread block 450 with heel-toe wear being scanned with a scanner 430.

FIG. 5 illustrates an elevational view of a tread block 550 with a removed element copy fitted in a void.

FIG. 6 illustrates a schematic of a system 600 for repairing a tire tread using a patch made via three-dimensional printing.

FIG. 7 illustrates a method 700 for repairing a tire tread using a patch made via three-dimensional printing.

### DETAILED DESCRIPTION

Various factors may cause irregular wear in a tire tread. For example, heel-toe wear may result from tire/wheel misalignment, including for example, excessive positive or negative toe. Additionally, tread wear may result from out of specification alignment including caster or camber settings. Tread wear may also result from over inflation, under inflation, or over loading of a tire. Finally, tread wear may result from steering angle input, which may result from a vehicle driving on a roadway with a crown (a crown may be used to cause water to run from a roadway, and may cause the vehicle operating on that roadway to have a certain degree of “roll”), wherein the vehicle must use steering angle input to keep the vehicle centered on the roadway.

Some tire tread patterns may be more susceptible to irregular wear than others. For example, a truck or bus radial steer tire with a straight rib, which may be commonly installed on large trucks and/or buses, may be susceptible to forming an irregular wear “spot” on an outside shoulder of the tread. In some tires, applied to various irregular wear-inducing factors such as tire/wheel misalignment and excess steering angle input, irregular wear may most commonly appear in the shoulder region of the tire, which is understood to include the axially-outer portions of the tire tread.

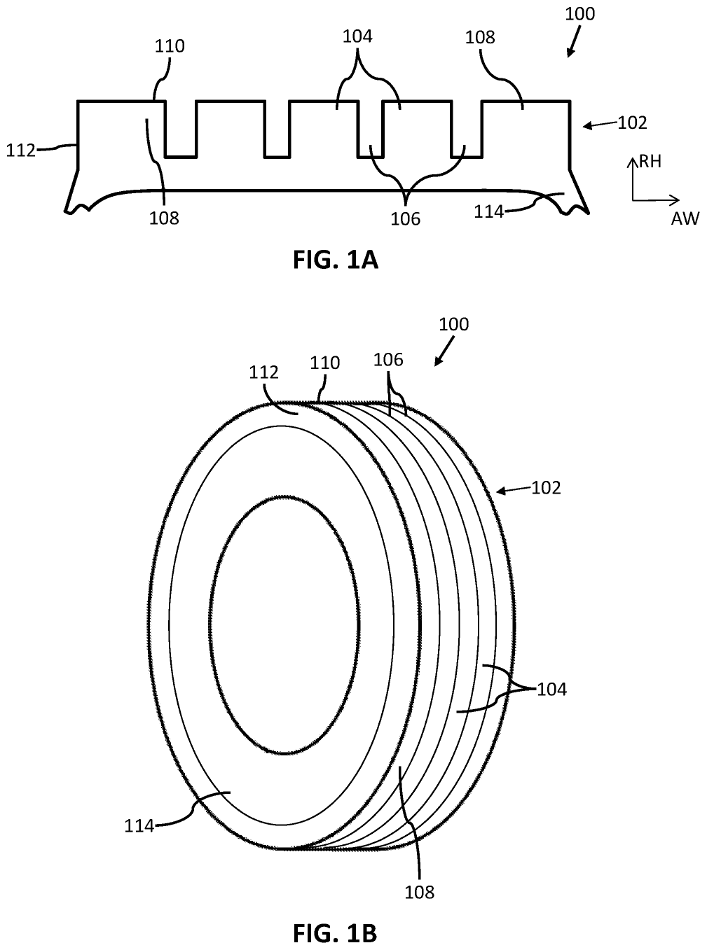

FIGS. 1A and 1B illustrate an example tire 100 without irregular wear. Tire 100 may include a tire tread portion 102 having at least one tread element 104. One tread element 104 may be separated from another tread element 104 by at least one circumferential groove 106. Tread portion 102 may include a plurality of tread elements 104 separated from one another by a plurality of circumferential grooves 106. Axially outermost tread elements 104 may include shoulder elements 108. Any of tread elements 104 and shoulder elements 108 may include a radially outermost surface 110. Any of tread elements 104 and shoulder elements 108 may include an element sidewall 112. Tire 100 may include tire sidewalls 114 oriented at a position at or near the generally axially outward edges of tread portion 102, and radially inwardly of tread portion 102.

At least one tread element 104, including shoulder elements 108, may be a tread block or a tread rib. A tread rib is understood to be a continuous circumferential tread element, while tread blocks are understood to be discontinuous in the circumferential direction and are broken up by transverse grooves. It is understood that tread portion 102 may be made up of a mixture of tread ribs and tread blocks, such that one or more tread element 104, including shoulder elements 108, may be a tread block, while one another of one or more tread element 104, including shoulder elements 108, may be a tread rib.

Circumferential groove 106 may include a continuous circumferential groove. Circumferential groove 106 may include a discontinuous circumferential groove. Circumferential groove 106 may include a plurality of circumferential grooves 106, including a mixture continuous circumferential grooves and discontinuous circumferential grooves.

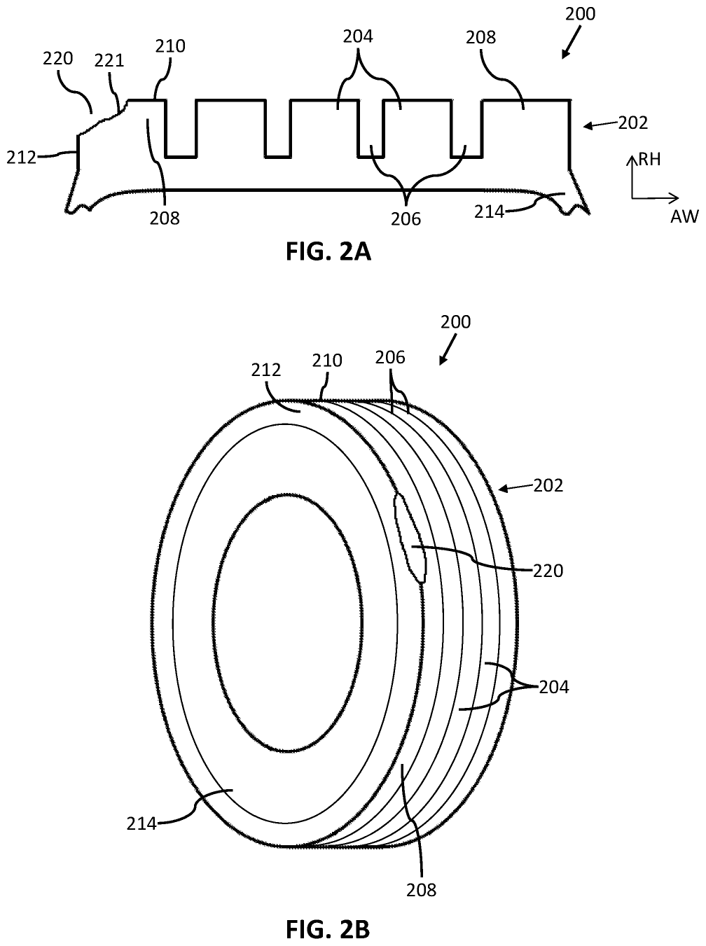

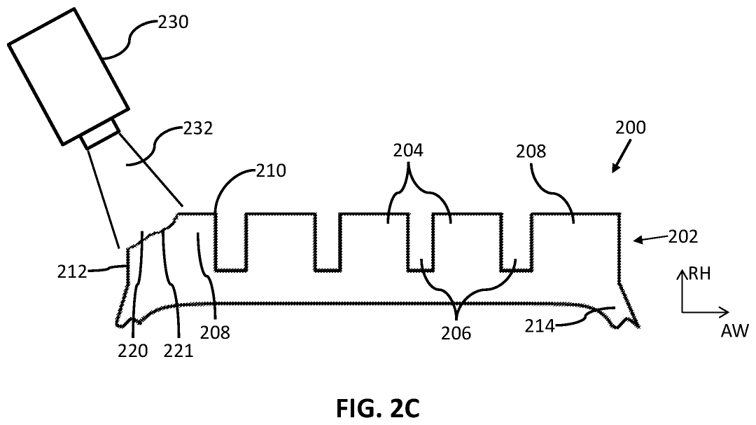

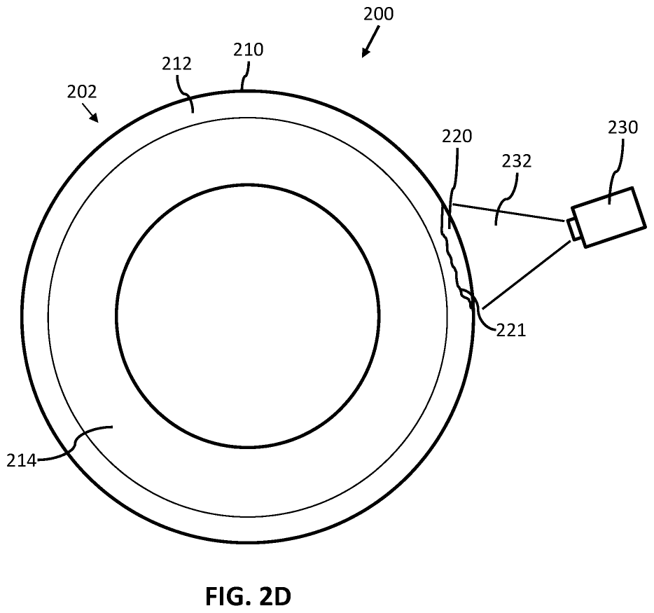

FIGS. 2A and 2B illustrate an example tire 200 with irregular wear. Tire 200 may include a tire tread portion 202 having at least one tread element 204. One tread element 204 may be separated from another tread element 204 by at least one circumferential groove 206. Tread portion 202 may include a plurality of tread elements 204 separated from one another by a plurality of circumferential grooves 206. Axially outermost tread elements 204 may include shoulder elements 208. Any of tread elements 204, including shoulder elements 208, may include a radially outermost surface 210. Any of tread elements 204, including shoulder elements 208, may include an element sidewall 212. Tire 200 may include tire sidewalls 214 oriented at a position at or near the generally axially outward edges of tread portion 202, and radially inwardly of tread portion 202.

At least one tread element 204, including shoulder elements 208, may be a tread block or a tread rib.

Tread portion 202 may include an irregular wear void 220. Void 220 may result from wear or damage of tread portion 202. Any of tread elements 204, including shoulder elements 208, may include void 220. Void 220 may leave a residual surface 221 in tread portion 202.

Void 220 may be an area where any tread element 204, including shoulder element 208, has been worn away or otherwise removed via damage to tread portion 202, leaving residual surface 221. Void 220 may be oriented in an axially outer portion of shoulder element 208. Void 220 may be oriented in any portion of shoulder element 208. Void 220 may be oriented in an axially outer portion of any tread element 204. Void 220 may be oriented in any portion of any tread element 204. Void 220 may include a localized area of wear or damage, not extending around the entire circumference of tire 200. Void 220 may have any of a variety of cross-sectional shapes, including for example, a substantially triangular shape. Void 220 may extend along a line inclined relative to a radial direction of tire 200.

Residual surface 221 may be any surface remaining after the formation of void 220. Residual surface 221 may be uneven, planar, rough or jagged (e.g., not smooth), smooth, and the like.

FIGS. 2C and 2D illustrate example tire 200 with irregular wear being scanned with a scanner 230.

Scanner 230 may be a three-dimensional (“3D”) scanner. Scanner 230 may be a laser scanner. Scanner 230 may be utilize light or laser energy 232 configured to reflect off of residual surface 221 and/or adjacent features of tread element 204, which is used to form a 3D computerized image of void 220. Scanner 230 may be a “time-of flight” 3D laser scanner. Scanner 230 may be a triangulation-based 3D laser scanner. Scanner 230 may be a hand-held laser scanner. Scanner 230 may create a point cloud of geometric samples on residual surface 221 and/or adjacent features of tread element 204, which points can be used to extrapolate the 3D shape of void 220 and/or adjacent features of tread element 204. Scanner 230 may include a device that physically touches residual surface 221 and/or adjacent features of tread element 204, including for example a contact 3D scanner. Scanner 230 may include a device that does not physically touch residual surface 221 and/or adjacent surface features of tread element 204, including for example an optical system scanner.

Scanner 230 may be any device capable of capturing the dimensions and shape of void 220 and/or adjacent surface features for use in creating a 3D model of void 220 and/or surface features of tread element 204 adjacent to void 220. Scanner 230 may be capable of capturing the dimensions and shape of void 220 and creating a negative of void 220 as a 3D computerized positive model, which represents a removed element copy that would fill in void 220 so as to cause tread element 204 to appear as it originally did before uneven wear, damage, or the like (e.g., like tread element 104 and/or shoulder element 108). Scanner 230, may be used to create a 3D model of tread element 204 (as illustrated, shoulder element 208) that was worn away to form void 220. That is, scanner 230 may be used to create a 3D computerized model of that portion of tread element 204/shoulder element 208 that was worn away due to damage, irregular wear, and the like. Scanner 230 may be connected to a computer (not shown), which may include software configured to create a the negative of void 220, which would be a positive removed element copy (not shown).

Scanner 230 may be exposed to void 220 in order to capture the dimensions and shape of void 220 and/or adjacent surface features. Scanner 230 may be configured and positioned so as to capture the dimensions and shape of void 220 and/or adjacent surface features from a stationary, single position. Alternatively, scanner 230 may be configured and positioned so as to be moved along an area of void 220 in order to capture the dimensions and shape of void 220 and/or adjacent surface features.

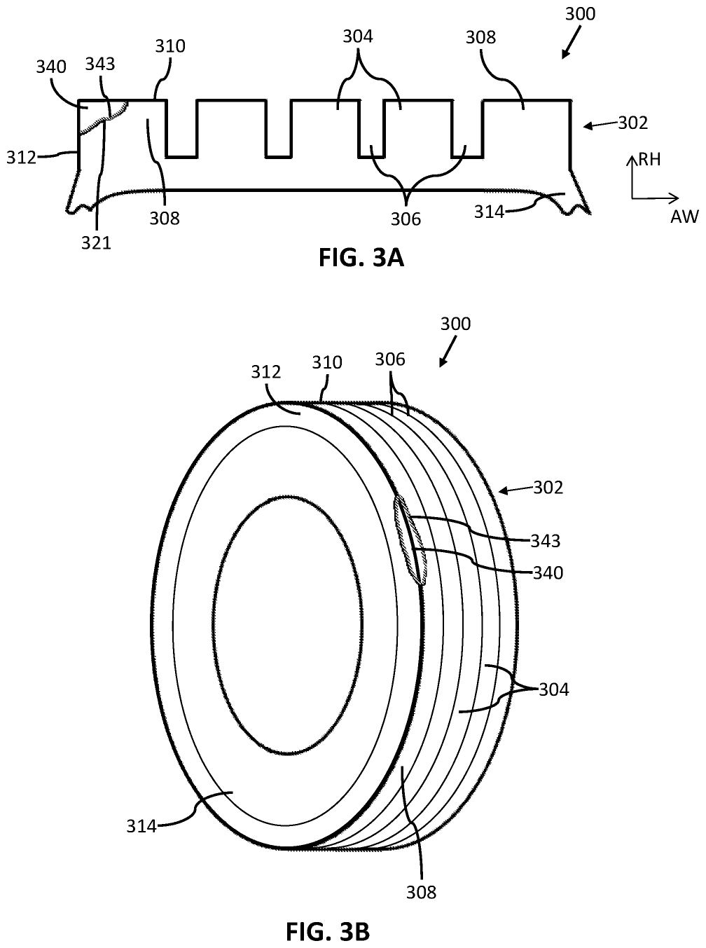

FIGS. 3A and 3B illustrate an example tire 300 with a removed element copy applied to a void. Tire 300 may include a tire tread portion 302 having at least one tread element 304. One tread element 304 may be separated from another tread element 304 by at least one circumferential groove 306. Tread portion 302 may include a plurality of tread elements 304 separated from one another by a plurality of circumferential grooves 306. Axially outermost tread elements 304 may include shoulder elements 308. Any of tread elements 304, including shoulder elements 308, may include a radially outermost surface 310. Any of tread elements 304, including shoulder elements 308, may include an element sidewall 312. Tire 300 may include tire sidewalls 314 oriented at a position at or near the generally axially outward edges of tread portion 302, and radially inwardly of tread portion 302.

At least one tread element 304, including shoulder elements 308, may be a tread block or a tread rib.

As described above, a scanner such as scanner 230 may create a positive computerized model of removed element copy 340. The computerized model may be sent to a 3D printer, configured to print a physical 3D model out of a material. The material may be any of a variety of materials, including for example, a polymer, a rubber, a metal, an alloy, a composite, and the like. The material may be the same material, or similar material, to that material used to form tread elements 304/shoulder elements 308. Any of a variety of computer programs may be used to prepare a physical removed element copy 340, including for example Creo by PTC, Needham, Mass., United States. Any of a variety of 3D printer systems may be used to create a physical removed element copy 340, including a 3D printer system configured to print using a rubber material.

The printed, physical, removed element copy 340 may correspond to the shape and dimension of a void, such as void 220. Removed element copy 340 may be placed into contact with residual surface 321. At least one surface of removed element copy 340 may directly correspond to the shape and dimensions of residual surface 321, such that the two surfaces mate.

An adhesive layer 343 may be placed upon residual surface 321. Removed element copy 340 may be placed upon adhesive layer 343 and into contact with residual surface 321. Adhesive layer 343 may be cured, thus bonding removed element copy 340 with residual surface 321.

The adhesive used in adhesive layer 343 may be any variety of adhesives capable of adhering two rubber items to one another. The adhesive may be cured via heat curing, which requires application of heat at a specified temperature, for a specified period of time to effect the curing of the adhesive. The adhesive may be a tire cement. The adhesive may be a self-vulcanizing cement, which does not require heat to cure. The adhesive may be a heat cure cement.

Removed element copy 340 may have dimensions perfectly matching those of the void, such as void 220, in the radial height, axial width, and circumferential length dimensions. Thus, following curing of adhesive layer 343, securing removed element copy 340 to residual surface 321, the radially outermost surface of removed element copy 340 may be even with the radially outermost surface 310 of tread element 304 adjacent to removed element copy 340. Likewise, following curing of adhesive layer 343, the axially outermost surface of removed element copy 340 may be even with element sidewall 312. Additionally, following curing of adhesive layer 343, the circumferentially outermost surfaces of removed element 340 may mate with the circumferentially outermost ends of residual surface 321.

Alternatively, removed element copy 340 may have dimensions slightly oversized relative to those of the void, such as void 220, in at least one of the radial height and axial width dimensions. Thus, following curing of adhesive layer 343, securing removed element copy 340 to residual surface 321, at least one of the radially outermost surface of removed element copy 340 and the axially outermost surface of removed element copy 340 may be trimmed and/or shaped to exactly match the remaining portions of tread element 304, including for example ensuring that removed element copy 340 is even with radially outermost surface 310 and element sidewall 312. Removed element copy 340 may be trimmed or otherwise shaped using any of a variety of mechanisms, including: via hand with a knife, cutting tool, rasp, saw, or the like, any of which may remove material in a predetermined shape; via a power tool such as a rotary or oscillating tire buffer, which may include a rasp, abrasive wheel, or abrasive cone, any of which may remove material in a predetermined shape; via an automated machine, including for example a robotic machine, which may employ any of a variety of cutters or tire buffers to the tire to remove a material in a predetermined shape.

Following curing of adhesive layer 343, securing removed element copy 340 to residual surface 321, tire 300 may be returned to service, and irregular wear may be mitigated, or stopped, as a result of adding removed element copy 340.

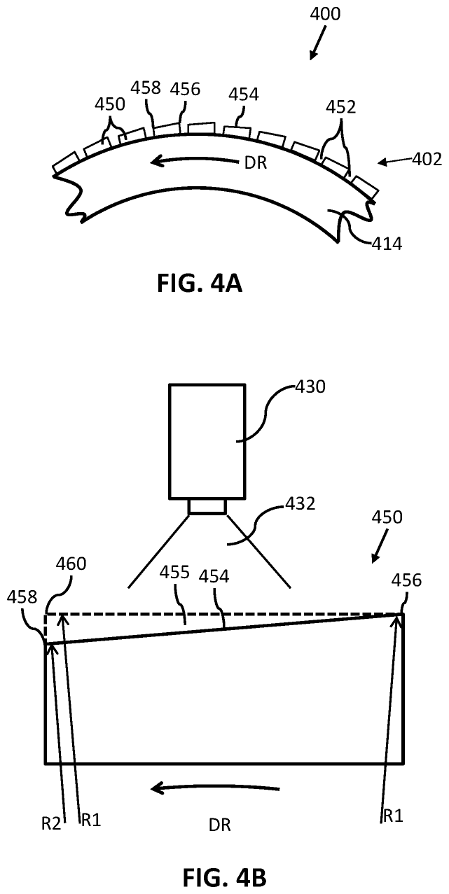

FIGS. 4A and 4B illustrate an example tire 400 and tread block 450 with heel-toe wear. Tire 400 may include a tread portion 402, a tire sidewall 414, a plurality of tread blocks 450 oriented in a series extending circumferentially, wherein adjacent tread blocks 450 separated by transverse grooves 452. Tread blocks 450 may include a radially outer residual surface 454, which may contact a roadway. Residual surface 454 may include a first end 456 having a radial height R1, and a second end 458 having a radial height R2. Radial height R1 may be greater than radial height R2. First end 456 and second end 458 may be circumferentially spaced from one another.

As illustrated, tire 400 may have a direction of rotation DR oriented counter-clockwise, such that second end 458 would strike a roadway first, and would thus be the heel, while first end 456 would strike the roadway second, and would thus be the toe. Therefore, as illustrated, tire 400 has irregular wear in a heel portion. It is understood that tire 400 could have irregular wear in a toe portion rather than the heel portion.

As illustrated in FIG. 4B, tread block 450 may have a residual surface 454 that is uneven from heel to toe. A dotted line and a point 460 indicates the desired height of second end 458, but for the irregular heel-toe wear. The area between the dotted line and residual surface 454 may form a void 455, where material was removed via irregular wear, damage to tread block 450, and the like. Point 460 is oriented at a radial height R1, which is the same as first end 456.

FIG. 4B further illustrates tread block 450 with irregular wear being scanned with a scanner 430.

Scanner 430 may be 3D scanner. Scanner 430 may be a laser scanner. Scanner 430 may be utilize light or laser energy 432 configured to reflect off of residual surface 454 and/or adjacent features of tread block 450, which is used to form a 3D computerized image of tread block 450. Scanner 430 may any of scanners 230 described above with respect to FIGS. 2C and 2D, and may likewise operate in the same manner as scanner 230.

Scanner 430 may be any device capable of capturing the dimensions and shape of void 455 and/or adjacent surface features for use in creating a 3D model of void 455 and/or surface features of tread block 450 adjacent to void 455. Scanner 430 may be capable of capturing the dimensions and shape of void 455 and creating a negative of void 455 as a 3D computerized positive model, which represents a removed element copy that would fill in void 455 so as to cause tread block 450 to appear as it originally did before uneven wear, damage, or the like. Scanner 430, may be used to create a 3D model of tread block 450 that was worn away to form void 455. That is, scanner 430 may be used to create a 3D computerized model of that portion of tread block 450 that was worn away due to damage, irregular wear, and the like. Scanner 430 may be connected to a computer (not shown), which may include software configured to create a the negative of void 455, which would be a positive removed element copy (not shown).

Scanner 430 may be exposed to void 455 in order to capture the dimensions and shape of void 455 and/or adjacent surface features. Scanner 430 may be configured and positioned so as to capture the dimensions and shape of void 455 and/or adjacent surface features from a stationary, single position. Alternatively, scanner 430 may be configured and positioned so as to be moved along an area of void 455 in order to capture the dimensions and shape of void 455 and/or adjacent surface features.

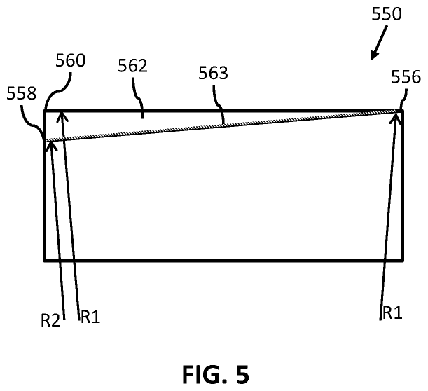

FIG. 5 illustrates an example tire tread block 550 with a removed element copy 562 applied to a void. Tread block 550 may include removed element copy adhered to residual surface (454) via an adhesive layer 563. Tread block 550 may include a radially outer residual surface (454). Residual surface (454) may include a first end 556 having a radial height R1, and a second end 558 having a radial height R2. Radial height 141 may be greater than radial height R2. First end 556 and second end 558 may be circumferentially spaced from one another.

Tread block 550 may have a residual surface (454) that was uneven from heel to toe. A point 560 indicates the desired height of second end 558, but for the irregular heel-toe wear. Point 560 may have a radial height R1, which may be the same as radial height 141 of first end 556.

Removed element copy 562 may have dimensions perfectly matching those of the void (455), at least in the radial height, circumferential length, and axial width dimensions.

As described above, a scanner such as scanner 430 (FIG. 4B) may create a positive computerized model of removed element copy 562. The computerized model may be sent to a 3D printer, configured to print a physical 3D model out of a material. The material may be any of a variety of materials, including for example, a polymer, a rubber, a metal, an alloy, a composite, and the like. The material may be the same material, or similar material, to that material used to form tread block 550. Any of a variety of computer programs may be used to prepare a physical removed element copy 562, including for example Creo by PTC, Needham, Mass., United States. Any of a variety of 3D printer systems may be used to create a physical removed element copy 562, including a 3D printer system configured to print using a rubber material.

The printed, physical, removed element copy 562 may correspond to the shape and dimension of a void, such as void (455). Removed element copy 562 may be placed into contact with residual surface (454). At least one surface of removed element copy 562 may directly correspond to the shape and dimensions of residual surface (454), such that the two surfaces mate.

An adhesive layer 563 may be placed upon residual surface (454). Removed element copy 562 may be placed upon adhesive layer 563 and into contact with residual surface (454). Adhesive layer 563 may be cured, thus bonding removed element copy 562 with residual surface (454).

The adhesive used in adhesive layer 563 may be any variety of adhesives capable of adhering two rubber items to one another. The adhesive may be cured via heat curing, which requires application of heat at a specified temperature, for a specified period of time to effect the curing of the adhesive. The adhesive may be a tire cement. The adhesive may be a self-vulcanizing cement, which does not require heat to cure. The adhesive may be a heat cure cement.

Removed element copy 562 may have dimensions perfectly matching those of the void, such as void 455, in the radial height, axial width, and circumferential length dimensions. Thus, following curing of adhesive layer 563, the axially outermost surfaces of removed element copy 562 may be even with the sidewalls of tread block 550 as they existed prior to application of removed element copy 562. Additionally, following curing of adhesive layer 563, the circumferentially outermost surfaces of removed element 562 may be even with the circumferentially outermost sidewalls of tread block 550 as they existed prior to application of removed element copy 562.

Alternatively, removed element copy 562 may have dimensions slightly oversized relative to those of the void, such as void 455, in at least one of the radial height, axial width, and circumferential length dimensions. Thus, following curing of adhesive layer 563, securing removed element copy 562 to residual surface (454), at least one of the radially outermost surface of removed element copy 562, the axially outermost surface of removed element copy 562, and the circumferentially outermost surface of removed element copy 562 may be trimmed and/or shaped to exactly match the remaining portions of tread block 550, including for example on its axially outermost sides and circumferentially outermost sides. Removed element copy 562 may be trimmed or otherwise shaped using any of a variety of mechanisms, including: via hand with a knife, cutting tool, rasp, saw, or the like, any of which may remove material in a predetermined shape; via a power tool such as a rotary or oscillating tire buffer, which may include a rasp, abrasive wheel, or abrasive cone, any of which may remove material in a predetermined shape; via an automated machine, including for example a robotic machine, which may employ any of a variety of cutters or tire buffers to the tire to remove a material in a predetermined shape.

Following curing of adhesive layer 563, securing removed element copy 562 to residual surface (454), a tire bearing read block 550 may be returned to service, and irregular wear may be mitigated, or stopped, as a result of adding removed element copy 562.

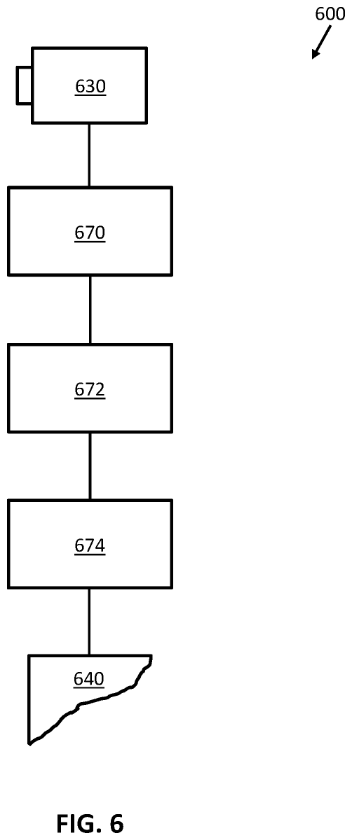

FIG. 6 illustrates a schematic of a system 600 for repairing a tire tread using a patch made via three-dimensional printing.

System 600 may include a scanner 630. Scanner 630 may be any of a variety of scanners, including those set forth above with respect to FIGS. 2D (230) and 4B (430).

Scanner 630 may be operatively connected to a computer 670. Computer 670 may be a CPU. Computer 670 may be any device capable of receiving electronic signals from scanner 630, processing these signals, and interacting with a 3D computer-aided design (“CAD”) program 672 operatively connected to computer 670.

CAD program 672 may interpret the electronic signals received by computer 670 from scanner 630, and form a computerized 3D model of at least one of a void (e.g., void 220 or void 455), residual surfaces of the void (e.g., residual surface 221 or residual surface 454), and remaining portions of the tread element containing the void (e.g., tread element 204, shoulder element 208, or tread block 450). CAD program 672 may identify the bounds of the void, such as the radially outermost edge of the void, based on a comparison with the radially outermost edge of remaining portions of the tread element and/or via user input. CAD program 672 may form a negative of the void (the void is already a negative), thus forming a positive model that represents the dimensions and shape of a removed element copy 640. CAD program 672 may be any of a variety of CAD programs, including for example Creo by PTC, Needham, Mass., United States.

CAD program 672 may be operatively connected to a 3D printer 674. 3D printer 674 may be configured to print a physical 3D model out of a material. The material may be any of a variety of materials, including for example, a polymer, a rubber, a metal, an alloy, a composite, and the like. The material may be the same material, or similar material, to that material used to form tread elements 304/shoulder elements 308, or tread block 550. 3D printer 674 may be any of a variety of 3D printer systems configured to create a physical removed element copy 640, including a 3D printer system configured to print using a rubber material.

3D printer 674 may create a physical removed element copy 640, which may have the shape and dimensions of the void upon which it was modeled, such that removed element copy 640 can be placed into the void and fill it accurately.

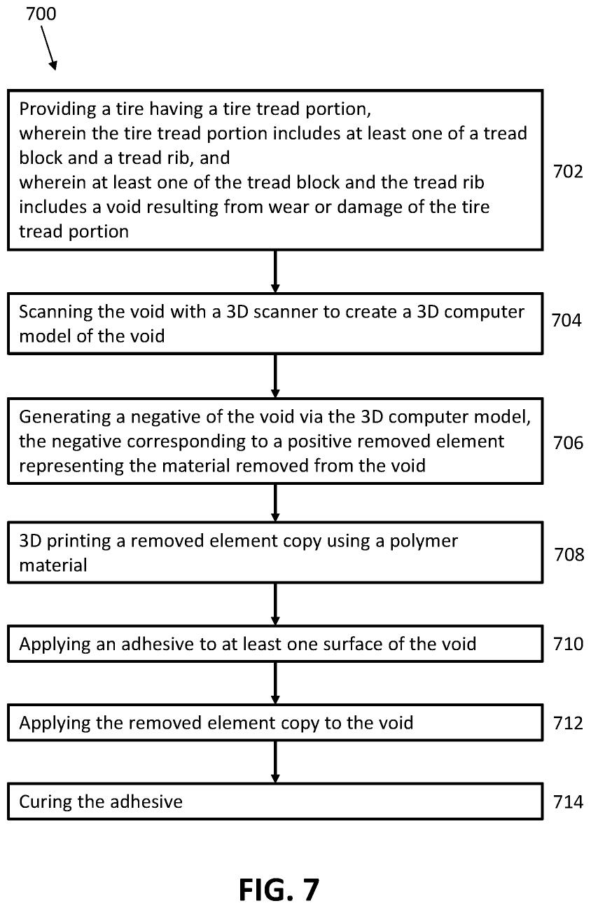

FIG. 7 illustrates a method 700 for repairing a tire tread. Method 700 may include: providing a tire having a tire tread portion, wherein the tire tread portion includes at least one of a tread block and a tread rib, and wherein at least one of the tread block and the tread rib includes a void resulting from wear or damage of the tire tread portion (step 702). Method 700 may further include: scanning the void with a 3D scanner to create a 3D computer model of the void (step 704). Method 700 may further include: generating a negative of the void via the 3D computer model, the negative corresponding to a positive removed element representing the material removed from the void (step 706). Method 700 may further include: 3D printing a removed element copy using a polymer material (step 708). Method 700 may further include: applying an adhesive to at least one surface of the void (step 710). Method 700 may further include: applying the removed element copy to the void (step 712). Method 700 may further include: curing the adhesive (step 714).

The method may additionally include fitting the removed element copy to the tread element and/or tread block via any method of cutting as described above, including for example, buffing.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “substantially” is used in the specification or the claims, it is intended to take into consideration the degree of precision available or prudent in manufacturing. To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. As used in the specification and the claims, the singular forms “a,” “an,” and “the” include the plural. Finally, where the term “about” is used in conjunction with a number, it is intended to include ±10% of the number. In other words, “about 10” may mean from 9 to 11. Cartesian coordinates referenced herein are intended to comply with the SAE tire coordinate system.

As stated above, while the present application has been illustrated by the description of various aspects thereof, and while the aspects have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

1. A method for repairing a tire tread, comprising:
providing a tire having a tire tread portion,
wherein the tire tread portion includes at least one of a tread block and a tread rib, and
wherein at least one of the tread block and the tread rib includes a void resulting from wear or damage of the tire tread portion;
scanning the void with a 3D scanner to create a 3D computer model of the void;
generating a negative of the void via the 3D computer model, the negative corresponding to a positive removed element representing the material removed from the void;
3D printing a removed element copy using a polymer material;
applying an adhesive to at least one surface of the void;
applying the removed element copy to the void; and
curing the adhesive.

2. The method of claim 1, wherein the void forms a residual surface in at least one of the tread block and the tread rib, and wherein the adhesive is applied to the residual surface.

3. The method of claim 2, wherein the removed element copy is applied to the residual surface.

4. The method of claim 1, wherein the 3D scanner is an optical scanner.

5. The method of claim 1, wherein the removed element copy has the same shape as the void.

6. The method of claim 1, wherein the removed element copy has the same dimensions as the void.

7. The method of claim 1, wherein the polymer material is a rubber material.

8. The method of claim 1, wherein the adhesive is a heat cure cement.

9. A method for repairing a tire tread, comprising:
providing a tire having a tire tread portion,
wherein the tire tread portion includes at least one of a tread block and a tread rib, and
wherein at least one of the tread block and the tread rib includes a void resulting from wear or damage of the tire tread portion;
scanning the void with a 3D optical scanner to create a 3D computer model of the void;
generating a negative of the void via the 3D computer model, the negative corresponding to a positive removed element representing the material removed from the void;
3D printing a removed element copy using a polymer material;
applying an adhesive to at least one surface of the void;
applying the removed element copy to the void; and
curing the adhesive.

10. The method of claim 9, wherein the void forms a residual surface in at least one of the tread block and the tread rib, and wherein the adhesive is applied to the residual surface.

11. The method of claim 10, wherein the removed element copy is applied to the residual surface.

12. The method of claim 9, wherein the removed element copy has the same shape as the void.

13. The method of claim 9, wherein the removed element copy has the same dimensions as the void.

14. The method of claim 9, wherein the polymer material is a rubber material.

15. The method of claim 9, wherein the adhesive is a heat cure cement.

16. A method for repairing a tire tread, comprising:
providing a tire having a tire tread portion,
wherein the tire tread portion includes at least one of a tread block and a tread rib, and
wherein at least one of the tread block and the tread rib includes a void resulting from wear or damage of the tire tread portion, the void forming a residual surface in at least one of the tread block and the tread rib;
scanning the void with a 3D optical scanner to create a 3D computer model of the void;
generating a negative of the void via the 3D computer model, the negative corresponding to a positive removed element representing the material removed from the void;
3D printing a removed element copy using a polymer material;
applying an adhesive to the residual surface of the void;
applying the removed element copy to the residual surface of the void; and
curing the adhesive.

17. The method of claim 16, wherein the removed element copy has the same shape as the void.

18. The method of claim 16, wherein the removed element copy has the same dimensions as the void.

19. The method of claim 16, wherein the polymer material is a rubber material.

20. The method of claim 16, wherein the adhesive is a heat cure cement.
